(19) United States
(12) Patent Application Publication
(10) Pub. No.: US 2014/0359617 A1
(43) Pub. Date: Dec. 4, 2014

(54) Patching a Virtual Image

(71) Applicant: International Business Machines Corporation, Armonk, NY (US)

(72) Inventors: Jacques Fontignie, Onex (CH); Claudio Marinelli, Rome (IT); Bernardo Pastorelli, Rome (IT); Luigi Pichetti, Rome (IT)

(21) Appl. No.: 14/363,487

(22) PCT Filed: Dec. 4, 2012
(86) PCT No.: PCT/IB2012/056945

§ 371 Date: Jun. 6, 2014

(30) Foreign Application Priority Data
Dec. 8, 2011 (EP) 11192589.7

(51) Int. Cl. G06F 9/445; G06F 9/44; G06F 9/455

(52) U.S. Cl. CPC G06F 8/65; G06F 9/45533; G06F 9/4401
USPC 718/1

(57) ABSTRACT

A mechanism for patching a virtual image modifies a selected dormant virtual image to be patched by injecting a corresponding patch logic and patch material to be applied on next boot during an off-line preparation phase. The mechanism downloads a boot medium and creates a temporary disk for a selected target virtual machine with corresponding deployment data The mechanism changes a master boot record of said temporary disk associated with the target virtual machine to boot next on the boot medium. The mechanism executes the patch logic to install the patch material in case the target virtual machine associated with the virtual image to be patched is booted.

### BACKGROUND

The present invention relates in general to the field of virtualization, and in particular to a mechanism for patching a virtual image and a system for patching a virtual image.

While virtualization brought a lot of advantages in terms of optimization of resources utilization it also introduced new challenges. The more evident issue is strictly tied on how to manage and maintain an increasing number of virtual images. Typically, virtual images are captured and stored in a central image repository and are maintained through versioning and provenance control mechanisms. Among the different maintenance actions, a key issue is how to bring those images to the same patch level. The security policies that usually are applied to running virtual or physical machines need to be also applied to dormant images. The more the deployment of an operating system patch is delayed the greater the risk of viruses infections once images are instantiated. The most common way to apply patches to dormant images is to instantiate them one by one in a segregated network just for the time required to deploy the change through standard deployment mechanisms; this approach has the major drawbacks, that it is inefficient that any dormant virtual image is re-instantiated for deploying the new patches even if it is not sure they will be used in the future; and even if the dormant virtual image is instantiated in a segregated network there is no guarantee to not have virus exposure.

In the Patent Publication U.S. Pat. No. 7,823,145 B1 “UPDATING SOFTWARE ON DORMANT DISKS” by Le et al. a system and method for scanning and updating software on a dormant disk is disclosed. The disclosed method of updating a dormant disk without requiring booting of the dormant disk uses an indirect mechanism, wherein the method includes the step of scanning a dormant disk to determine a current status of the dormant disk, determining whether the updates are available and applying the updates to the dormant disk using the indirect mechanism. The indirect mechanism includes means for storing a script on the dormant disk, wherein the script is configured to update the files upon booting of the dormant disk. The document describes a traditional way to patch off-line virtual images, and relies on the concept to re-instantiate the virtual image in a segregated network just for patching purposes.

### SUMMARY

The technical problem underlying the present invention is to provide a mechanism for patching a virtual image and a system for patching a virtual image, which are able to apply any change including device driver modification and to solve the above mentioned inefficiencies, shortcomings and pain points of prior art virtual image patching.

Accordingly, in an illustrative embodiment, a method for patching a virtual image comprises modifying a selected dormant virtual image to be patched by injecting a corresponding patch logic, and patch material to be applied on next boot during an off-line preparation phase; downloading a boot medium and creating a temporary disk for a selected target virtual machine with corresponding deployment data; changing a master boot record of the temporary disk associated with the target virtual machine to boot next on the boot medium; and executing the patch logic to install the patch material in case the target virtual machine associated with the virtual image to be patched is booted.

In another illustrative embodiment, a system for patching a virtual image comprises a browser, an image provisioning server with an image repository holding at least one virtual image, and a virtualization infrastructure comprising at least one hypervisor running at least one virtual machine; wherein the browser is used to select a dormant virtual image to be patched from the image repository, patch material to be applied, and a target virtual machine; wherein the selected dormant virtual image to be patched is modified by injecting a corresponding patch logic, and the patch material to be applied on next boot during an off-line preparation phase; wherein the image provisioning server contacts an on screen display an operating System deployment (OSD) tool of the virtualization infrastructure to download a boot medium and to create a temporary disk for the selected target virtual machine with corresponding deployment data; Wherein the on screen display (OSD) tool changes a master boot record of the temporary disk associated with the target virtual machine to boot next on the boot medium; and executes the patch logic to install the patch material in case the target virtual machine associated with the virtual image to be patched is booted.

In yet another embodiment of the present invention, a computer program product stored on a computer-usable medium, comprises computer-readable program means for causing a computer to perform the method described above for patching a virtual image when the program is run on the computer.

The above, as well as additional purposes, features, and advantages of the present invention will become apparent in the following detailed written description.

### BRIEF DESCRIPTION OF THE SEVERAL VIEWS OF THE DRAWINGS

Illustrative embodiments of the present invention, as described in detail below, are shown in the drawings, in which:

FIG. 1 is a schematic block diagram of a system for patching a virtual image, in accordance with an illustrative embodiment; and

FIG. 2 is a schematic flow diagram of a method for patching a virtual image, in accordance with an illustrative embodiment.

### DETAILED DESCRIPTION

The illustrative embodiments prepare an off-line dormant virtual image to be patched and postpone the actual patching when the virtual image is re-instantiated in the production environment. This is obtained by modifying the virtual image injecting off-line the proper patch logic and the material comprising a patch software module, and a pre-operating system environment to be applied on a next boot process. A key aspect of the embodiments is that once the virtual machine associated to the virtual image boots, the patch logic is executed on top of a pre-operating system environment, for example WinPE for the Windows® operating system (a trademark of Microsoft corporation) and the pre-boot operating system for Altiris™ Deployment Solution™ (Altiris and Deployment Solution are trademarks of Symantec Corporation) for the Linux™ operating System (Linux is a trademark of Linus Torvalds). This would happen when the network is still not available preventing any virus attack. In addition to resolving the security concern, the illustrative embodiments guarantee that patches are applied just when actually needed, dramatically reducing the inefficiency of the traditional approaches.

While some of the prior art solutions describe the step to do indirect/postponed patch preparing the dormant virtual image to be patched at boot time, the illustrative embodiments have a significant difference that also brings evident advantages if compared with the prior art solutions. While the prior art mechanism modify the dormant virtual image including directly in the virtual image itself the update scripts, the illustrative embodiments do not apply these changes but just modify the master boot record (MBR) to force the machine to boot on a loaded boot medium, for example an ISO file (image), instead of the hard disk. This means that at boot time the control is taken by the pre-operating system environment included in the loaded boot medium that would start an agent that directly accesses the virtual image itself and applies the changes to it. This implies that it is possible to apply any change including device driver modification that are not possible in the prior art solutions. So, the target system boots from an intermediate boot medium, for example the ISO disk, and the patch is applied only on the local target virtual machine (VM) disk.

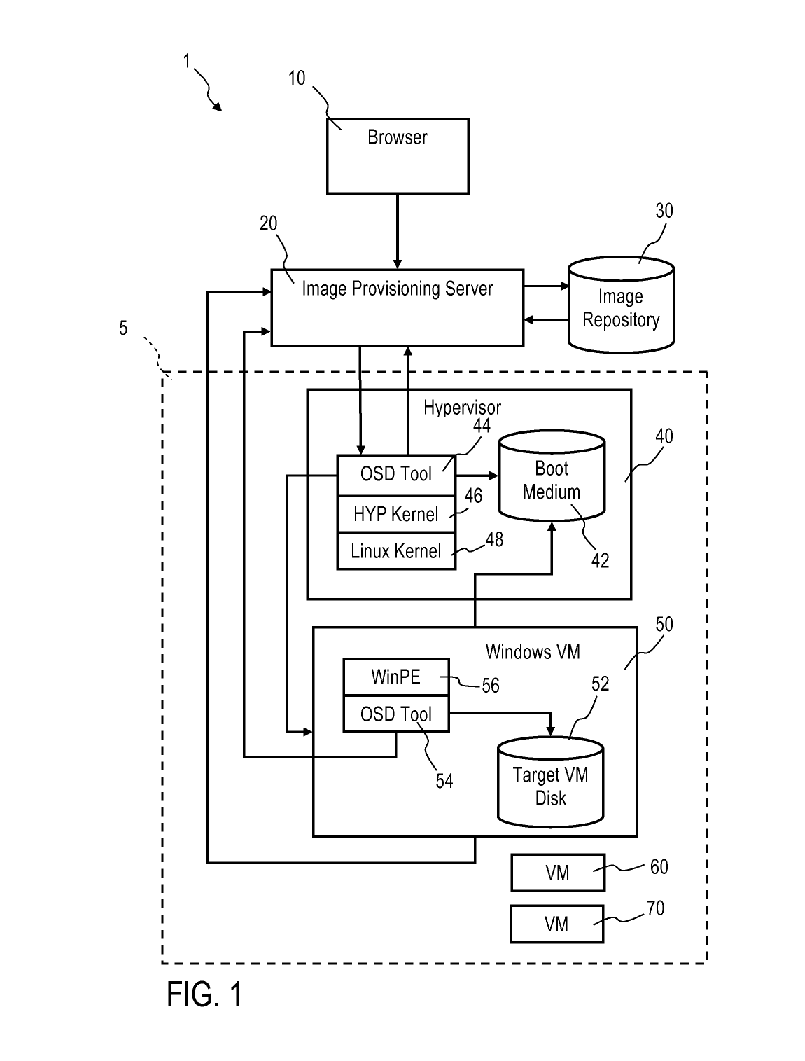

FIG. 1 shows a system for patching a virtual image, in accordance with an illustrative embodiment.

Referring to FIG. 1, the shown embodiment employs a system 1 for patching a virtual image comprising a browser 10, an image provisioning server 20 with an image repository 30 holding at least one virtual image, and a virtualization infrastructure 5 comprising at least one hypervisor 40 running at least one virtual machine 50, 60, 70. In the shown embodiment the hypervisor 40 is implemented as, for instance, the VMware™ ESX hypervisor (VMware is a trademark of VMware Inc.) type comprising a boot medium 42, an on screen display (OSD) tool 44, a hypervisor (HYP) Kernel and a Linux™ Kernel, for example, and the image provisioning server 20 is implemented as Tivoli provisioning manager for images (TPMfImages). Even if these hypervisor and image provisioning server types are mentioned, the embodiments may work without any difference varying the hypervisor and image provisioning server types.

The browser 10 is used to select a dormant virtual image to be patched from the image repository 30, patch material to he applied, and a target virtual machine 50; wherein the selected dormant virtual image to be patched is modified by injecting a corresponding patch logic, and the patch material to be applied on next boot during an off-line preparation phase.

The image provisioning server 20 contacts the on screen display (OSD) tool 44 of the virtualization infrastructure 5 to download the boot medium 42 and to create a temporary disk 52 for the selected target virtual machine 50 with corresponding deployment data. The on screen display (OSD) tool 44 changes a master boot record (MBR) of the temporary disk 52 associated with the target virtual machine 50 to boot next on the boot medium 42 and executes the patch logic to install the patch material in case the target virtual machine 50 associated with the virtual image to be patched is booted.

The patch material comprises a patch software module and information about a pre-operating system environment 56 to be used for patching of the selected dormant virtual image.

In other words, during the patch preparation phase, an operator selects the virtual image to be patched, the software module to apply including the patch and the patching method like immediate, next reboot or scheduled. If “next reboot” and “image deployment with patching” are selected, the image provisioning server 20 binds the software module to the virtual image to be deployed.

During the virtual image patch deployment phase, the operator selects the target virtual machine 50 and triggers a deployment action. In reaction to the trigger process the image provisioning server 20 contacts the on screen display (OSD) tool 44 running on the hypervisor 40. The on screen display (OSD) tool 44 downloads a network boot ISO image as boot medium, for example, and creates the temporary virtual machine (VM) disk 52 with the deployment data. The on screen display (OSD) tool 44 changes the master boot record (MBR) of the virtual machine (VM) disk 52 in order to boot on the ISO file (image) as boot medium 42. The on screen display (OSD) tool 44 starts the virtual machine (VM) 50. The virtual machine (VM) 50 boots on the ISO file (image) as boot medium 42, and the pre-operating system 56 and the on screen display (OSD) tool 54 are downloaded from the hypervisor 40 and loaded in a ram disk. Then virtual images are mounted and the files are downloaded and deployed. The on screen display (OSD) tool 56 runs agent to prepare the operating system (OS), to inject the device drivers and to install the patch software module. So the patch software module is executed on top of the pre-operating system 56.

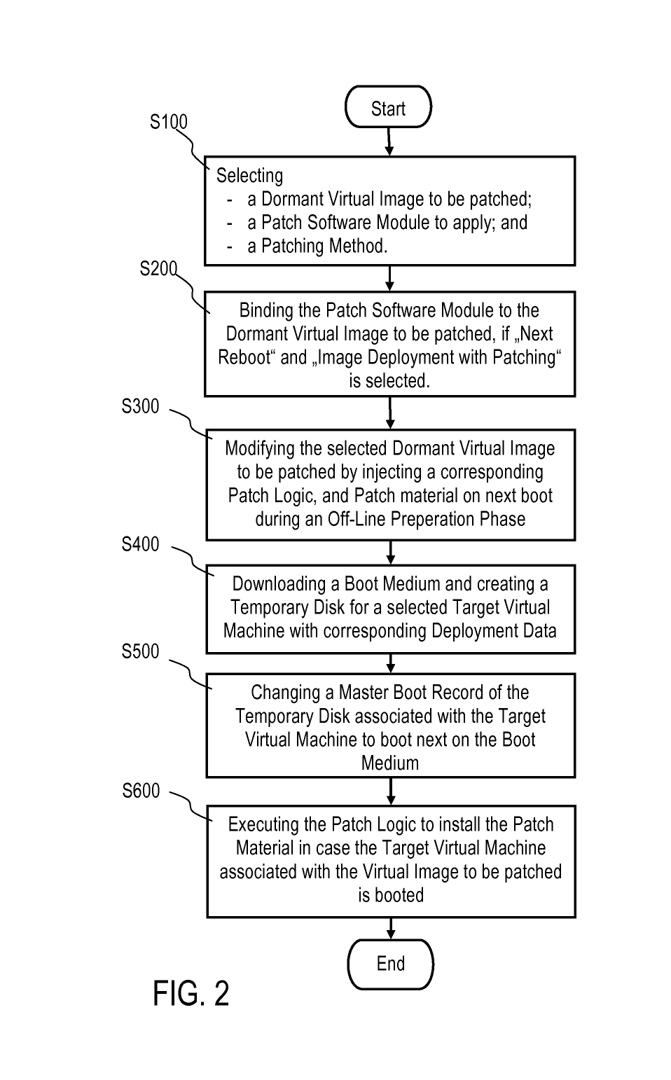

FIG. 2 shows a method for patching a virtual image, in accordance with an illustrative embodiment.

Referring to FIG. 2, the shown embodiment employs a method for patching a virtual image. In step S100, a dormant virtual image to be patched, a patch software module to apply, and a patching method are selected. In step S200, the patch software module is bound to the dormant virtual image to be patched, if “next reboot” and “image deployment with patching” are selected as patching method.

In step S300, the selected dormant virtual image to be patched is modified by injecting a corresponding patch logic and patch material to be applied on next boot during an off-line preparation phase. In step S400, a boot medium 42 is downloaded, and a temporary disk 52 for a selected. target virtual machine 50 is created with corresponding deployment data. In step S500, a master boot record of the temporary disk 52 associated with the target virtual machine 50 is changed to boot next on the boot medium 42. In step S600, the patch logic is executed to install the patch material in case the target virtual machine 50 associated with the virtual image to be patched is booted.

The patch material comprises a patch software module and information about the pre-operating system environment 56 to be used for patching the selected dormant virtual image. The pre-operating system environment 56 is started by the boot medium 42 during booting of the target virtual machine 50 associated with the virtual image to be patched and taking control of the patching process, wherein said patch software module is executed on top of said pre-operating system environment 56. As mentioned above, the pre-operating system environment 56 starts an agent directly accessing the selected virtual image to be patched and applying changes according to the patch software module.

The illustrative embodiments can be implemented as an entirely software embodiment, or an embodiment containing both hardware and software elements. In one embodiment embodiment, the present invention is implemented. in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. input/output or 110 devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

1. A method for patching a virtual image, the method comprising:
modifying a selected dormant virtual image to be patched by injecting corresponding patch logic aid patch material to be applied on next boot within an off-line preparation phase;
downloading a boot medium and creating a temporary disk for a selected target virtual machine with corresponding deployment data;
changing a master boot record of the temporary disk associated with the target virtual machine to boot next on the boot medium; and
executing the patch logic to install the patch material responsive to determining the target virtual machine associated with the virtual image to be patched is booted.

2. The method according to claim 1, wherein the patch material comprises a patch software module and information about a pre-operating system environment to be used for patching the selected dormant virtual image.

3. The method according to claim 2, wherein the pre-operating system environment is started by the boot medium responsive to initiating booting of the target virtual machine associated with the virtual image to be patched and takes control of patching the selected dormant virtual image.

4. The method according to claim 3, wherein the patch software module is executed within the pre-operating system environment.

5. The method according to claim 3, wherein the pre-operating system environment starts an agent directly accessing the elected target virtual image and applies changes according to the patch software module.

6. The method according to claim 1, wherein a patching method is selected within the off-line preparation phase.

7. The method according to claim 6, wherein the virtual image to he patched and the patch software module to apply are selected and bound within the off-line preparation phase responsive to determining the selected patching method is a next reboot patching method and virtual image deployment with patching is selected.

8. The method according to claim 1, wherein the boot medium is a disk archive image.

9. A system for patching a virtual image, the system comprising:
an image provisioning server with an image repository holding at least one virtual image, and a virtualization infrastructure comprising at least one hypervisor running at least one virtual machine;
wherein a browser is used to select a dormant virtual image to be patched from the image repository, patch material to be applied, and a target virtual machine;
wherein the selected dormant virtual image to be patched is modified by injecting a corresponding patch logic and the patch material to be applied on next boot within an off-line preparation phase;
wherein the image provisioning server contacts an on screen display tool of the virtualization infrastructure to download a boot medium and to create a temporary disk for the selected target virtual machine with corresponding deployment data;
wherein the on screen display tool changes a master boot record of said the temporary disk associated with the target virtual machine to boot next on the boot medium; and
wherein the on screen display tool executes the patch logic to install the patch material responsive to determining the target virtual machine associated with the virtual image to be patched is booted.

10. The system according to claim 9, wherein the patch material comprises a patch software module and information about a pre-operating system environment to be used for patching of the selected dormant virtual image.

11. The system according to claim 10, wherein the on screen display tool starts the target virtual machine, wherein the target virtual machine boots on a disk archive image;
wherein the target virtual machine downloads the pre-operating system environment and the on screen display tool from the hypervisor to the temporary disk, mounts the virtual image to be patched, and downloads and deploys corresponding files.

12. The system according to claim 11, wherein the patch software module is executed within the pre-operating system environment.

13. The system according to claim 11, wherein the pre-operating system environment starts an agent directly accessing the selected virtual image and applies changes according to the patch software module.

14. (canceled)

15. A computer program product comprising a computer-usable storage medium having stored therein a computer-readable program, wherein the computer readable program, when executed on a computing device, causes the computing device to:
modify a selected dormant virtual image to be patched by injecting a corresponding patch logic and patch material to be applied on next boot within an off-line preparation phase;
download a boot medium and creating a temporary disk for a selected target virtual machine with corresponding deployment data;
change a master boot record o the temporary disk associated with the target virtual machine to boot next on the boot medium; and
execute the patch logic to install the patch material responsive to determining the target virtual machine associated with the virtual image to be patched is booted.

16. The computer program product according to claim 15, wherein the patch material comprises a patch software module and information a bout a pre-operating system environment to be used for patching the selected dormant virtual image.

17. The computer program product according to claim 16, wherein the pre operating system environment is started by the boot medium responsive to initiating booting of the target virtual machine associated with the virtual image to be patched and takes control of patching the selected dormant virtual image.

18. The computer program product according to claim 17, wherein the patch software module is executed within the pre-operating system environment.

19. The computer program product according to claim 17, wherein the pre-operating system environment starts an agent directly accessing the selected target virtual image and applies changes according to the patch software module.

20. The computer program product according to claim 19, wherein a patching method is selected within the off-line preparation phase.

21. The computer program product according to claim 20, wherein the virtual image to be patched and the patch software module to apply are selected and bound within the offline preparation phase responsive to determining the selected patching method is a next reboot patching method and virtual image deployment with patching is selected.
